(19) United States
(12) Patent Application Publication
(10) Pub. No.: US 2024/0406961 A1
(43) Pub. Date: Dec. 5, 2024

(54) METHOD AND APPARATUS FOR BEAM DETERMINATION

(71) Applicant: LENOVO (BEIJING) LIMITED, Beijing (CN)

(72) Inventors: Wei Ling, Beijing (CN); Yi Zhang, Beijing (CN); Chenxi Zhu, Beijing (CN); Bingchao Liu, Beijing (CN); Lingling Xiao, Beijing (CN)

(21) Appl. No.: 18/699,507

(22) PCT Filed: Oct. 8, 2021
(86) PCT No.: PCT/CN2021/122643

§ 371 Date: Apr. 8, 2024

(51) Int. Cl. H04W 72/21; H04B 7/06; H04B 7/08

(52) U.S. Cl. CPC H04W 72/21; H04B 7/06968; H04B 7/088

(57) ABSTRACT

Embodiments of the present application relate to methods and apparatuses for beam determination. An exemplary method for beam determination may include: receiving a first DCI, wherein two common TCI states are indicated by a TCI codepoint of a TCI field in the first DCI: receiving a signaling including beam indication information for a data transmission, wherein the data transmission is a PDSCH or a PUSCH; and in the case that the two common TCI states are two joint or DL common TCI states and the data transmission is a PDSCH, receiving the PDSCH according to the beam indication information in at least one slot indicated by the signaling where the two common TCI states are applicable; and in the case that the two common TCI states are two UL common TCI states and the data transmission is a PUSCH, transmitting the PUSCH according to the beam indication information in at least one slot indicated by the signaling where the two common TCI states are applicable.

### TECHNICAL FIELD

Embodiments of the present application are related to wireless communication technology, especially, related to a method and apparatus for beam determination.

### BACKGROUND OF THE INVENTION

Regarding enhancements on multiple-input multiple-output (MIMO) for new radio (NR), a work item description (WID) approved in NR R17 includes enhancement on multi-beam operation, mainly targeting frequency range (FR)2 while also applicable to FR1. Wherein, a research topic is to identify and specify features to facilitate more efficient (lower latency and overhead) downlink/uplink (DL/UL) beam management to support higher intra-band and L1/L2-centric inter-cell mobility and/or a larger number of configured transmission configuration indication (TCI) states, including common beam for data and control transmission/reception for DL and UL, especially for intra-band carrier aggregation (CA).

In R17, only one joint or DL common beam is indicated for DL transmission, and only one joint or UL common beam is indicated for UL transmission. Thus, only one joint or DL common beam is used for physical downlink shared channel (PDSCH) reception and only one joint or UL common beam is used for physical uplink shared channel (PUSCH) transmission. Although common beam indication in a scenario of multiple transmit-receive points (TRPs) will not be discussed in R17, it may be further studied in R18 which has been discussed in R18 workshop. Then, more than one joint or DL common beam (and/or more than one joint or UL common beam) may be indicated by a downlink control information (DCI) for the scenario of multiple TRPs in R18. For example, if two joint or DL common beams are indicated for DL transmission for multi-TRP transmission, one or two joint or DL common beams can be applied for a PDSCH which is transmitted by a single TRP (also referred to as S-TRP) or multiple TRPs (also referred to as M-TRP). Considering to support the dynamic switching between S-TRP PDSCH transmission and M-TRP PDSCH transmission, it is not fast and efficient by correspondingly updating the common beam(s) indicated by the DCI because common beam(s) can only be applicable from a first slot which is at least Y symbols after the last symbol of the acknowledgment of the joint or DL beam indication in the DCI. It may need to switch between S-TRP PDSCH transmission and M-TRP PDSCH transmission frequently when two joint or DL common beams are applicable. The same issue will also happen when considering to support the dynamic switching between S-TRP PUSCH transmission and M-TRP PUSCH transmission.

Therefore, the industry desires a technical solution to indicate common beam(s) for a PDSCH and/or PUSCH to switch between S-TRP PDSCH and/or PUSCH transmission and M-TRP PDSCH and/or PUSCH transmission dynamically and fast.

### SUMMARY

One objective of the embodiments of the present application is to provide a technical solution for beam determination, especially for beam determination for PDSCH and/or PUSCH considering dynamic switching between S-TRP transmission and M-TRP transmission.

Some embodiments of the present application provide an apparatus, which includes: at least one receiving circuitry; at least one transmitting circuitry; and at least one processor coupled to the at least one receiving circuitry and the at least one transmitting circuitry, wherein the at least one processor is configured to: receive a first DCI, wherein two common TCI states are indicated by a TCI codepoint of a TCI field in the first DCI; receive a signaling including beam indication information for a data transmission, wherein the data transmission is a PDSCH or a PUSCH; and in the case that the two common TCI states are two joint or DL common TCI states and the data transmission is a PDSCH, receive the PDSCH according to the beam indication information in at least one slot indicated by the signaling where the two common TCI states are applicable; and in the case that the two common TCI states are two joint or UL common TCI states and the data transmission is a PUSCH, transmit the PUSCH according to the beam indication information in at least one slot indicated by the signaling where the two common TCI states are applicable.

Some embodiments of the present application provide an apparatus, which includes: at least one receiving circuitry; at least one transmitting circuitry; and at least one processor coupled to the at least one receiving circuitry and the at least one transmitting circuitry, wherein the at least one processor is configured to: transmit a first DCI, wherein two common TCI states are indicated by a TCI codepoint of a TCI field in the first DCI; transmit a signaling including beam indication information for a data transmission, wherein the data transmission is a PDSCH or a PUSCH; and in the case that the two common TCI states are two joint or DL common TCI states and the data transmission is a PDSCH, transmit the PDSCH according to beam indication information in at least one slot indicated by the signaling where the two common TCI states are applicable; and in the case that the two common TCI states are two joint or UL common TCI states and the data transmission is a PUSCH, receive the PUSCH according to the beam indication information in at least one slot indicated by the signaling where the two common TCI states are applicable.

According to some embodiments of the present application, the beam indication information indicates a first common TCI state of the two common TCI states is determined for the PDSCH or PUSCH, wherein demodulation-reference signal (DM-RS) antenna ports of the PDSCH are quasi co-located (QCL) with a set of RSs in the first common TCI state with respect to a set of QCL parameters, or a spatial transmit filter of the PUSCH is according to a RS configured with QCL-Type D of the first common TCI state.

According to some other embodiments of the present application, the beam indication information indicates a second common TCI state of the two common TCI states is determined for the PDSCH or PUSCH, wherein DM-RS antenna ports of the PDSCH are quasi co-located with a set of RSs in the second common TCI state with respect to a set of QCL parameters, or a spatial transmit filter of the PUSCH is according to a RS configured with QCL-Type D of the second common TCI state.

According to some yet other embodiments of the present application, the beam indication information indicates both the two common TCI states are determined for the PDSCH or PUSCH, wherein DM-RS antenna ports of the PDSCH are quasi co-located with a set of RSs in the two common TCI states with respect to a set of QCL parameters, or spatial transmit filters of the PUSCH are according to RSs configured with QCL-Type D of the two common TCI states.

According to some embodiments of the present application, the signaling is a scheduling or activating DCI for the data transmission in the case that the data transmission is a PDSCH or a PUSCH expect for configured grant Type 1 PUSCH, and the beam indication information is indicated in a corresponding field in the scheduling or activating DCI, wherein whether the corresponding field is present in the scheduling or activating DCI is configured by a radio resource control (RRC) signaling.

According to some other embodiments of the present application, the signaling is a RRC configuration for the data transmission in the case that the data transmission is a configured grant Type 1 PUSCH.

According to some embodiments of the present application, the two common TCI states are applicable from a first slot which is at least a number of symbols of acknowledgment of the first DCI, wherein the number of symbols is configured by a RRC signaling based on a capability of the UE.

Some embodiments of the present application provide a method, including: receiving a first DCI, wherein two common TCI states are indicated by a TCI codepoint of a TCI field in the first DCI; receiving a signaling including beam indication information for a data transmission, wherein the data transmission is a PDSCH or a PUSCH; and in the case that the two common TCI states are two joint or DL common TCI states and the data transmission is a PDSCH, receiving the PDSCH according to the beam indication information in at least one slot indicated by the signaling where the two common TCI states are applicable; and in the case that the two common TCI states are two UL common TCI states and the data transmission is a PUSCH, transmitting the PUSCH according to the beam indication information in at least one slot indicated by the signaling where the two common TCI states are applicable.

Some other embodiments of the present application provide another method, including: transmitting a first DCI, wherein two common TCI states are indicated by a TCI codepoint of a TCI field in the first DCI; transmitting a signaling including beam indication information for a data transmission, wherein the data transmission is a PDSCH or a PUSCH; and in the case that the two common TCI states are two joint or DL common TCI states and the data transmission is a PDSCH, transmitting the PDSCH according to the beam indication information in at least one slot indicated by the signaling where the two common TCI states are applicable; and in the case that the two common TCI states are two joint or UL common TCI states and the data transmission is a PUSCH, receiving the PUSCH according to the beam indication information in at least one slot indicated by the signaling where the two common TCI states are applicable.

Embodiments of the present application can solve the beam determination for PDSCH and PUSCH when multiple (e.g., two) joint or separate DL/UL common beams are applicable in a slot, and thus will facilitate the deployment and implementation of the NR.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 is a schematic diagram illustrating an exemplary wireless communication system according to some embodiments of the present application;

FIG. 2 illustrates a flow chart of a method for beam determination according to some embodiments of the present application;

FIG. 3 illustrates an exemplary beam determination procedure according to some embodiments of the present application;

FIG. 4 illustrates a simplified block diagram of an apparatus for beam determination according to some embodiments of the present application; and

FIG. 5 is a block diagram of an apparatus for beam determination according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE) Release 8 and so on. It is contemplated that along with the developments of network architectures and new service scenarios, all embodiments in the present application are also applicable to similar technical problems; and moreover, the terminologies recited in the present application may change, which should not affect the principle of the present application.

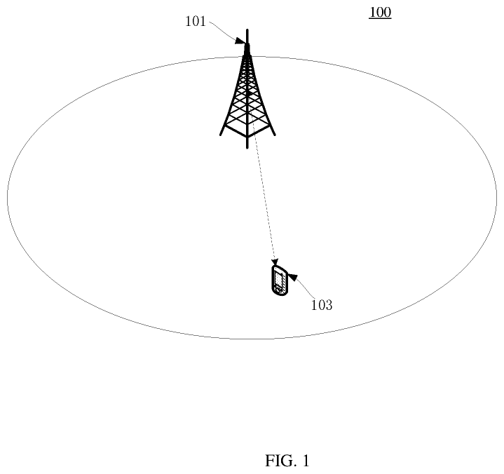

FIG. 1 illustrates a schematic diagram of an exemplary wireless communication system 100 according to some embodiments of the present application.

As shown in FIG. 1, the wireless communication system 100 includes a UE 103 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

In R17, common beam for data and control transmission/reception for DL and UL, especially for intra-band CA is introduced to improve latency and efficiency with more usage of dynamic control signaling. The terminology “beam” can be represented by or associated with spatial relation information, TCI state, RS etc. For example, a beam for PDSCH can be illustrated as: a TCI state wherein DM-RS antenna ports of the PDSCH are quasi co-located with a set of RSs in a TCI state with respect to a set of QCL parameters; and a beam for PUSCH can be illustrated as: a spatial transmit filter of the PUSCH which is according to a RS configured with QCL-Type D of a TCI state.

It has been agreed to reuse DCI format 1_1 and DCI format 1_2 for joint or DL common beam indication in R17. When a joint or DL common beam is indicated by DCI in a PDCCH (hereafter, “DCI in a PDCCH” is also referred to a DCI), it will be applied to all or part of a set of CORESETs configured for a UE and all PDSCHs. In R17, only one joint or DL common beam is indicated for DL transmission, and thus, only one joint or DL common beam is used for PDSCH reception. In R18, two or more joint or DL common beams may be indicated for DL transmission for multiple TRP transmission. In addition, in R16, two TCI states are applied for a PDSCH scheme 1 which is non-coherent joint transmission (NCJT) transmission by 2 TRPs. Besides, two TCI states are applied for a PDSCH in the single frequency network (SFN) mode in R17. Regarding PUSCH, as discussed in R18 workshop, simultaneously transmission of multiple panels will be supported for UL transmission. Therefore, up to two common beams can be used for a PUSCH transmission occasion similar to PDSCH. Although one or two common TCI states are indicated by a codepoint of the TCI field in a DCI, which can be used to switch single TRP transmission and multiple TRP transmission, there is a long time duration for the beam switching where the new common beams can only be applicable after Y symbols of the corresponding HARQ-ACK of the DCI containing the TCI field. If the dynamic switching between single TRP PDSCH and/or PUSCH transmission and multiple TRP PDSCH and/or PUSCH transmission is based on the TCI field of the DCI, it is not fast and efficient as desired.

At least for solving the above technical problems, embodiments of the present application provide a technical solution for beam determination, especially for beam determination of PDSCH and PUSCH when there are two or more joint or separate DL/UL common beams are applicable in at least one slot.

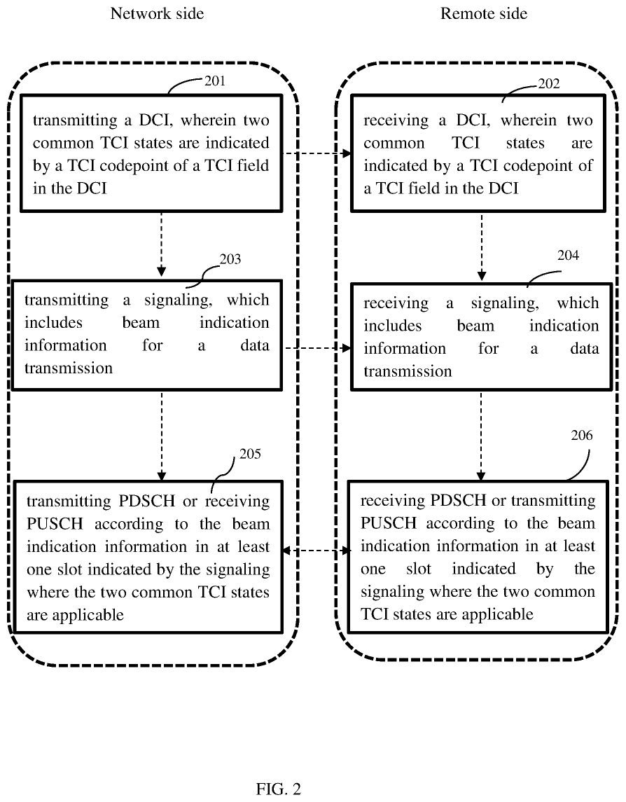

FIG. 2 illustrates a flow chart of a method for beam determination according to some embodiments of the present application. Although the method is illustrated in a system level by an apparatus in a remote side (or a UE side) and an apparatus in a network side (or a BS side), persons skilled in the art should understand that the method implemented in the remote side and that implemented in the network side can be separately implemented and incorporated by other apparatus with the like functions.

As shown in FIG. 2, in step 201, the network side, e.g., the BS 101 as shown in FIG. 1 will indicate one or more common beams by a DCI (herein, also referring to as a first DCI for simplification and clarification) to the remote side. For example, the one or more common beams may be one or more joint or DL common beams represented by one or more joint or DL common TCI states indicated by a TCI codepoint in a TCI field of a DCI, or one or more joint or UL common beams represented by one or more joint or UL common TCI states indicated by a codepoint in a TCI field of a DCI. Accordingly, the remote side, e.g., the UE 103 as shown in FIG. 1 will receive the first DCI in step 202. Herein, embodiments of the present application are illustrated concerning on at most two common beams, e.g., two joint or DL common TCI states or two joint or UL common TCI states indicated by a TCI codepoint in a TCI field of a DCI. However, persons skilled in the art should well know that the illustrated technical solution would also be applied to similar scenarios with more than two common beams.

Meanwhile, when the common beam is indicated by a DCI, it is valid starting from an applicable time, which is the first slot that is at least a number of symbols configured by a RRC signaling according to UE capability after the acknowledgement (ACK) of the DCI for indicating the common beam(s).

For example, according to the agreement in RAN1 #104b-e, regarding the application time of the beam indication, the first slot to apply the indicated TCI state is at least Y symbols after the last symbol of the acknowledgment of the common beam indication, e.g., joint or DL common beam indication or joint or UL common beam indication. The Y symbols are configured by the gNB based on UE capability via a RRC signaling, which is also reported in units of symbols. For another example, in RAN1 #106bis-e, on Rel-17 DCI-based beam indication, regarding the application time of the beam indication, further down select one from the following alternatives for the case of CA:
Alt1: The first slot and the Y symbols are both determined on the carrier with the smallest SCS among the carrier(s) applying the beam indication
Alt2: The first slot and the Y symbols are both determined on the carrier with smallest SCS among the carrier(s) applying the beam indication and the UL carrier carrying the acknowledgment
Alt3: The first slot and the Y symbols are both determined on the UL carrier carrying the acknowledgment.

In step 203, the network side, e.g., the BS as shown in FIG. 1 may transmit a signaling to the remote side, which includes beam indication information for a data transmission. Accordingly, in the remote side, e.g., the UE 103 as shown in FIG. 1 may receive the signaling in step 204. The data transmission may be a PDSCH or a PUSCH. When the remote side supports dynamic single TRP PDSCH transmission and multiple TRP PDSCH transmission, which joint or DL common beam(s) is applied for the PDSCH is determined (or indicated) according to the beam indication information. Similarly, when the remote side supports dynamic single TRP PUSCH transmission and multiple TRP PUSCH transmission, which joint or UL common beam(s) is applied for the PUSCH is also determined (or indicated) according to the beam indication information.

For example, the signaling may be a DCI for scheduling or activating a PDSCH or a PUSCH expect for configured grant Type 1 PUSCH (also referred to as a second DCI for simplification and clarification), and the beam indication information is indicated in a corresponding field in the second DCI. According to some embodiments of the present application, whether the corresponding field is present in the second DCI is configured by a RRC signaling, which is novel compared with the legacy RRC configuration. It should be noted that the corresponding field is only valid for a scheduled or activated data transmission when two common beams, e.g., two joint or DL common TCI states, or two joint or UL common TCI states are applicable in at least one slot where the data transmission, e.g., PDSCH is received in the remote side or the data transmission, e.g., PUSCH is transmitted in the remote side. If only one common beam, e.g., only one joint or DL common TCL state, or only one joint or UL common TCI state is applicable in the at least one slot, the only one common beam is determined for the data transmission regardless of the beam indication information in the second DCI.

In some embodiments of the present application, at least 2 bits can be used for the corresponding field for indicating the beam indication information in the second DCI for scheduling or activating a data transmission, wherein the data transmission is a PDSCH or PUSCH. When there are two common TCI states indicated by a TCI codepoint in a TCI field in a DCI which are applicable in at least one slot where the scheduled or activated data transmission is received or transmitted, the corresponding field in the second DCI can indicate which common TCI state(s) of the two common TCI states for the data transmission scheduled or activated by the second DCI. For example, at least three states can be indicated by the corresponding field with 2 bits as shown in Table 1.

TABLE 1

| corresponding | TCI state(s) applied for a data transmission |
|---|---|
| field in a DCI | scheduled by the DCI |
| 00 | The first common TCI state |
| 01 | The second common TCI state |
| 10 | The first and second common TCI states |
| 11 | Reserved state |

Specifically, Table 1 illustrates the beam indication information for a data transmission scheduled or activated by a DCI, e.g., the second DCI, wherein an exemplary corresponding field indicates the beam indication information with three states (the fourth one is reserved) by 2 bits. The first state set in the corresponding field is represented by “00,” which indicates the first common TCI state of the two common TCI states is determined for a data transmission scheduled or activated by the second DCI. For example, for a PDSCH scheduled or activated by the second DCI in at least one slot, the first joint or DL common TCI state of two joint or DL common TCI states applicable in the at least one slot is determined for the PDSCH; and for a PUSCH scheduled or activated by the second DCI in at least one slot, the first joint or UL common TCI state of the two joint or UL common TCI states applicable in the at least one slot is determined for the PUSCH. The second state set in the corresponding field is represented by “01,” which indicates the second common TCI state of the two common TCI states is determined for a data transmission scheduled or activated by the second DCI. For example, for a PDSCH scheduled or activated by the second DCI in at least one slot, the second joint or DL common TCI state of two joint or DL common TCI states applicable in the at least one slot is determined for the PDSCH; and for a PUSCH scheduled or activated by the second DCI in at least one slot, the second joint or UL common TCI state of the two joint or UL common TCI states applicable in the at least one slot is determined for the PUSCH. The third state set in the corresponding field is represented by “10,” which indicates both the two common TCI states, i.e., the first and second common TCI state are determined for a data transmission scheduled or activated by the second DCI. For example, for a PDSCH scheduled or activated by the second DCI in at least one slot, both the two joint or DL common TCI states applicable in the at least one slot are determined for the PDSCH; and for a PUSCH scheduled or activated by the second DCI in at least one slot, both the two joint or UL common TCI states applicable in the at least one slot is determined for the PUSCH. The fourth state “11” can be reserved in the exemplary corresponding field, or it can further indicate two joint or UL common TCI states are applicable for a PUSCH transmission whose repetition number is larger than 1 with a time division multiplex (TDM) manner according to a configured beam mapping pattern.

Persons skilled in the art should understand that the exemplary corresponding field in Table 1 is only for illustrating the principle of the corresponding field configuration. The specific information indicated by each exemplary state can be changed, and more than three states can be defined with more than two bits. For example, the first state set as “00” may indicates both the two common TCI states, i.e., the first and second common TCI state are determined for a data transmission scheduled or activated by the second DCI. In another example, when there are three common TCI states are applicable in a slot, three bits may be used to define more states, e.g., “000” can be used to indicate that the first common TCI state of the three common TCI states is determined for a data transmission scheduled or activated by a DCI.

In some embodiments of the present application, the data transmission is a configured grant Type 1 PUSCH, and the signaling is a RRC configuration for a configured grant Type 1 PUSCH. The beam indication information in the RRC configuration is an optional parameter for the configured grant Type 1 PUSCH, and can be configured in a similar manner to the correspond field in the second DCI. For example, when the parameter for the beam indication information is “00,” it indicates that the first joint or UL common TCI state of two joint or UL common TCI states is determined for the configured grant Type 1 PUSCH. When the parameter for the beam indication information is “01,” it indicates that the second joint or UL common TCI state of two joint or UL common TCI states is determined for the configured grant Type 1 PUSCH. When the parameter for the beam indication information is “10,” it indicates that the two joint or UL common TCI states are determined for the configured grant Type 1 PUSCH. The parameter for the beam indication information may be set as ‘11’ where it may further indicate two joint or UL common TCI states are applicable for the configured grant Type 1 PUSCH whose repetition number is larger than 1 with a TDM manner according to a configured beam mapping pattern. When such a RRC parameter is not included in the RRC signaling, default configuration information can be used for beam determination, for example, the first joint or UL common TCI state is always determined for the configured grant Type 1 PUSCH. Similarly, the RRC parameter is only valid when two joint or UL common beams are applicable for the configured grant Type 1 PUSCH in the at least one slot.

In step 205, the network side, e.g., the BS 101 as shown in FIG. 1 may transmit the PDSCH to the remote side, e.g., the UE 103 as shown in FIG. 1 or transmit the PDSCH to the remote side according to the beam indication information in at least one slot indicated by the signaling where the two common TCI states are applicable. Consistently, in step 206, the remote side, e.g., the UE 103 as shown in FIG. 1 may receive the PDSCH from the network side, e.g., the BS 101 as shown in FIG. 1 or transmit the PUSCH to the network side according to the beam indication information in at least one slot indicated by the signaling where the two common TCI states are applicable.

According to current 3GPP specification(s), receiving/transmitting a beam of downlink transmission can be represented by decoding/transmitting the resource elements (REs) of a DM-RS antenna port quasi co-located associated with a set of RS, e.g. a synchronization signal (SS)/physical broadcast channel (PBCH) block (SSB) or a channel state information-reference signal (CSI-RS) resource, or one or more RSs configured by a TCI state. Herein, a joint or DL common beam for PDSCH can be represented by a joint or DL common TCI state. And receiving/transmitting a beam of a joint or UL common beam for PUSCH can be represented by receiving/transmitting a spatial transmit filter of the PUSCH which is according to a RS configured with QCL-Type D of a joint or UL common TCI state. Herein, a joint or UL common beam for PUSCH can be represented by a joint or UL common TCI state.

Accordingly, in the case that the beam indication information indicates a first joint or DL common TCI state of the two joint or DL common TCI states applicable in at least one slot is determined for the PDSCH, the apparatus in the remote side, e.g., the UE 103 in FIG. 1, will receive the PDSCH transmitted from the apparatus in the network side, e.g., the BS 101 as shown in FIG. 1 in the at least one slot, wherein DM-RS antenna ports of the PDSCH are quasi co-located with a set of RSs in the first joint or DL common TCI state with respect to a set of QCL parameters. In the case that the beam indication information indicates a second joint or DL common TCI state of the two joint or DL common TCI states applicable in at least one slot is determined for the PDSCH, the apparatus in the remote side, e.g., the UE 103 in FIG. 1, will receive the PDSCH transmitted from the apparatus in the network side, e.g., the BS 101 as shown in FIG. 1 in the at least one slot, wherein DM-RS antenna ports of the PDSCH are quasi co-located with a set of RSs in the second joint or DL common TCI state with respect to a set of QCL parameters. In the case that the beam indication information indicates both the two joint or DL common TCI states applicable in at least one slot are determined for the PDSCH, the apparatus in the remote side, e.g., the UE 103 as shown in FIG. 1 will receive the PDSCH transmitted from the apparatus in the network side, e.g., the BS 101 in FIG. 1, in the at least one slot, wherein DM-RS antenna ports of the PDSCH are quasi co-located with a set of RSs in both the two joint or DL common TCI states with respect to a set of QCL parameters.

Similarly, in the case that the beam indication information indicates a first joint or UL common TCI state of the two joint or UL common TCI states applicable in at least one slot is determined for the PUSCH, the apparatus in the remote side, e.g., the UE 103 in FIG. 1, will transmit the PUSCH to the apparatus in the network side, e.g., the BS 101 as shown in FIG. 1 in the at least one slot, wherein a spatial transmit filter of the PUSCH is according to a RS configured with QCL-Type D of the first joint or UL common TCI state. In the case that the beam indication information indicates a second joint or UL common TCI state of the two joint or UL common TCI states applicable in at least one slot is determined for the PUSCH, the apparatus in the remote side, e.g., the UE 103 in FIG. 1, will transmit the PUSCH to the apparatus in the network side, e.g., the BS 101 as shown in FIG. 1 in the at least one slot, wherein a spatial transmit filter of the PUSCH is according to a RS configured with QCL-Type D of the second joint or UL common TCI state. In the case that the beam indication information indicates both the two joint or UL common TCI states applicable in at least one slot are determined for the PUSCH, the apparatus in the remote side, e.g., the UE 103 in FIG. 1, will transmit the PUSCH to the apparatus in the network side, e.g., the BS 101 as shown in FIG. 1 in the at least one slot, wherein spatial transmit filters of the PUSCH are according to a RS configured with QCL-Type D of the both two joint or UL common TCI states.

FIG. 3 illustrates an exemplary beam determination procedure according to some embodiments of the present application.

As shown in FIG. 3, it is assumed that two DL common TCI states for DL transmission, e.g., TCI state 1 and TCI state 2 are indicated by a TCI codepoint field in a DCI. Besides, it is assumed that TCI state 1 and TCI state 2 are applicable from slot n. A DCI, e.g., DCI 1 in slot n schedules a first PDSCH, e.g., PDSCH 1 in slot n+1, where the corresponding field indicating beam indication information of the first PDSCH in DCI 1 is set as “00.” Another DCI, e.g., DCI 2 in slot n+2 schedules a second PDSCH, e.g., PDSCH 2 in slot n+3, where the corresponding field indicating beam indication information of the second PDSCH in DCI 2 is set as “01.” A yet another DCI, e.g., DCI 3 in slot n+4 schedules a third PDSCH, e.g., PDSCH 3 in slot n+5, where the corresponding field indicating beam indication information of the third PDSCH in DCI 3 is set as “10.” According to Table 1 as illustrated above, the first DL common TCI state, e.g., TCI state 1 is determined for PDSCH 1 according to the beam indication information in DCI 1; the second DL common TCI state, e.g., TCI state 2 is determined for PDSCH 2 according to the beam indication information in DCI 2; and the two DL common TCI states, e.g., TCI state 1 and TCI state 2 are determined for PDSCH 3 according to the beam indication information in DCI 3. Accordingly, the UE will receive PDSCH 1 in slot n+1 where the DM-RS ports of PDSCH 1 are quasi co-located with the RS(s) in TCI state 1 with respect to the QCL type parameter(s), will receive PDSCH 2 in slot n+3 where the DM-RS ports of PDSCH 2 are quasi co-located with the RS(s) in TCI state 2 with respect to the QCL type parameter(s), and will receive PDSCH 3 in slot n+5 where the DM-RS ports of PDSCH 3 are quasi co-located with the RS(s) in both TCI state 1 and TCI state 2 with respect to the QCL type parameter(s).

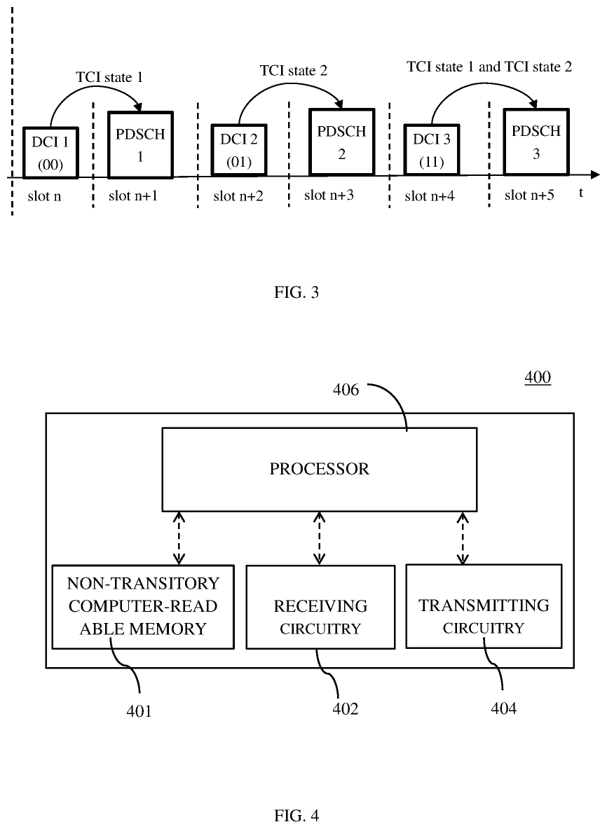

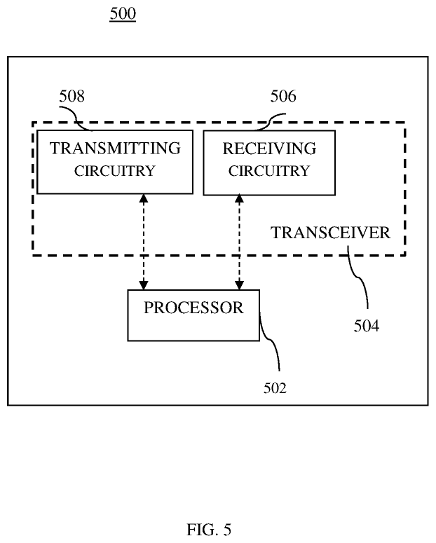

Besides methods, embodiments of the present application also propose an apparatus for beam determination. For example, FIG. 4 illustrates a block diagram of an apparatus 400 for beam determination according to some embodiments of the present application.

As shown in FIG. 4, the apparatus 400 may include at least one non-transitory computer-readable medium 401, at least one receiving circuitry 402, at least one transmitting circuitry 404, and at least one processor 406 coupled to the non-transitory computer-readable medium 401, the receiving circuitry 402 and the transmitting circuitry 404. The apparatus 400 may be a terminal device (e.g., a UE) configured to perform a method illustrated in the above or the like.

Although in this figure, elements such as the at least one processor 606, transmitting circuitry 404, and receiving circuitry 402 are described in the singular, the plural is contemplated unless a limitation to the singular is explicitly stated. In some embodiments of the present application, the receiving circuitry 402 and the transmitting circuitry 404 can be combined into a single device, such as a transceiver. In certain embodiments of the present application, the apparatus 400 may further include an input device, a memory, and/or other components.

In some embodiments of the present application, the non-transitory computer-readable medium 401 may have stored thereon computer-executable instructions to cause a processor to implement the method with respect to the terminal device as described above. For example, the computer-executable instructions, when executed, cause the processor 406 interacting with receiving circuitry 402 and transmitting circuitry 404, so as to perform the steps with respect to the apparatus in the remote side, e.g., UE as depicted above.

In some embodiments of the present application, the non-transitory computer-readable medium 401 may have stored thereon computer-executable instructions to cause a processor to implement the method with respect to the CU or DU as described above. For example, the computer-executable instructions, when executed, cause the processor 406 interacting with receiving circuitry 402 and transmitting circuitry 404, so as to perform the steps with respect to the apparatus in the network side, e.g., a BS illustrated above.

FIG. 5 is a block diagram of an apparatus for beam determination according to some other embodiments of the present application.

Referring to FIG. 5, the apparatus 500, for example a UE or a BS may include at least one processor 502 and at least one transceiver 504 coupled to the at least one processor 502. The transceiver 504 may include at least one separate receiving circuitry 506 and transmitting circuitry 508, or at least one integrated receiving circuitry 506 and transmitting circuitry 508.

According to some embodiments of the present application, when the apparatus 500 is a UE, the processor is configured to: receive a first DCI, wherein two common TCI states are indicated by a TCI codepoint of a TCI field in the first DCI; receive a signaling including beam indication information for a data transmission, wherein the data transmission is a PDSCH or a PUSCH; and in the case that the two common TCI states are two joint or DL common TCI states and the data transmission is a PDSCH, receive the PDSCH according to the beam indication information in at least one slot indicated by the signaling where the two common TCI states are applicable; and in the case that the two common TCI states are two joint or UL common TCI states and the data transmission is a PUSCH, transmit the PUSCH according to the beam indication information in at least one slot indicated by the signaling where the two common TCI states are applicable.

According to some other embodiments of the present application, when the apparatus 500 is a BS, the processor may be configured to: transmit a first DCI, wherein two common TCI states are indicated by a TCI codepoint of a TCI field in the first DCI; transmit a signaling including beam indication information for a data transmission, wherein the data transmission is a PDSCH or a PUSCH; and in the case that the two common TCI states are two joint or DL common TCI states and the data transmission is a PDSCH, transmit the PDSCH according to beam indication information in at least one slot indicated by the signaling where the two common TCI states are applicable; and in the case that the two common TCI states are two joint or UL common TCI states and the data transmission is a PUSCH, receive the PUSCH according to the beam indication information in at least one slot indicated by the signaling where the two common TCI states are applicable.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE), comprising:
at least one memory; and
at least one processor coupled with the at least one memory and configured to cause the UE to:
receive a first downlink control information (DCI), wherein two common transmission configuration indication (TCI) states are indicated by a TCI field in the first DCI;
receive a signaling including beam indication information for a data transmission, wherein the data transmission is a physical downlink shared channel (PDSCH) or a physical downlink shared channel (PUSCH); and
in the case that the two common TCI states are two joint or downlink (DL) common TCI states and the data transmission is a PDSCH, receive the PDSCH according to the beam indication information in at least one slot indicated by the signaling where the two common TCI states are applicable; and
in the case that the two common TCI states are two joint or uplink (UL) common TCI states and the data transmission is a PUSCH, transmit the PUSCH according to the beam indication information in at least one slot indicated by the signaling where the two common TCI states are applicable.

2. The UE of claim 1, wherein, the beam indication information indicates a first common TCI state of the two common TCI states is determined for the PDSCH or PUSCH, wherein demodulation-reference signal (DM-RS) antenna ports of the PDSCH are quasi co-located (QCL) with a set of RSs in the first common TCI state with respect to a set of QCL parameters, or a spatial transmit filter of the PUSCH is according to a RS configured with QCL-Type D of the first common TCI state.

3. The UE of claim 1, wherein, the beam indication information indicates a second common TCI state of the two common TCI states is determined for the PDSCH or PUSCH, wherein demodulation-reference signal (DM-RS) antenna ports of the PDSCH are quasi co-located (QCL) with a set of RSs in the second common TCI state with respect to a set of QCL parameters, or a spatial transmit filter of the PUSCH is according to a RS configured with QCL-Type D of the second common TCI state.

4. The UE of claim 1, wherein, the beam indication information indicates both the two common TCI states are determined for the PDSCH or PUSCH, wherein demodulation-reference signal (DM-RS) antenna ports of the PDSCH are quasi co-located (QCL) with a set of RSs in the two common TCI states with respect to a set of QCL parameters, or spatial transmit filters of the PUSCH are according to RSs configured with QCL-Type D of the two common TCI states.

5. The UE of claim 1, wherein, the signaling is a scheduling or activating DCI for the data transmission in the case that the data transmission is a PDSCH or a PUSCH expect for configured grant Type 1 PUSCH, and the beam indication information is indicated in a corresponding field in the scheduling or activating DCI, wherein whether the corresponding field is present in the scheduling or activating DCI is configured by a radio resource control (RRC) signaling.

6. The UE of claim 1, wherein, the signaling is a radio resource control (RRC) configuration for the data transmission in the case that the data transmission is a configured grant Type 1 PUSCH.

7. The UE of claim 1, wherein, the two common TCI states are applicable from a first slot which is at least a number of symbols of acknowledgment of the first DCI, wherein the number of symbols is configured by a radio resource control (RRC) signaling based on a capability of the UE.

8. A base station, comprising:
at least one memory; and
at least one processor coupled with the at least one memory and configured to cause the base station to:
transmit a first downlink control information (DCI), wherein two common transmission configuration indication (TCI) states are indicated by a TCI field in the first DCI;
transmit a signaling including beam indication information for a data transmission, wherein the data transmission is a physical downlink shared channel (PDSCH) or a physical downlink shared channel (PUSCH); and
in the case that the two common TCI states are two joint or downlink (DL) common TCI states and the data transmission is a PDSCH, transmit the PDSCH according to beam indication information in at least one slot indicated by the signaling where the two common TCI states are applicable; and
in the case that the two common TCI states are two joint or uplink (UL) common TCI states and the data transmission is a PUSCH, receive the PUSCH according to the beam indication information in at least one slot indicated by the signaling where the two common TCI states are applicable.

9. The base station of claim 8, wherein, the beam indication information indicates a first common TCI state of the two common TCI states is determined for the PDSCH or PUSCH, wherein demodulation-reference signal (DM-RS) antenna ports of the PDSCH are quasi co-located (QCL) with a set of RSs in the first common TCI state with respect to a set of QCL parameters, or a spatial transmit filter of the PUSCH is according to a RS configured with QCL-Type D of the first common TCI state.

10. The base station of claim 8, wherein, the beam indication information indicates a second common TCI state of the two common TCI states is determined for the PDSCH or PUSCH, wherein demodulation-reference signal (DM-RS) antenna ports of the PDSCH are quasi co-located (QCL) with a set of RSs in the second common TCI state with respect to a set of QCL parameters, or a spatial transmit filter of the PUSCH is according to a RS configured with QCL-Type D of the second common TCI state.

11. The base station of claim 8, wherein, the beam indication information indicates both the two common TCI states are determined for the PDSCH or PUSCH, wherein demodulation-reference signal (DM-RS) antenna ports of the PDSCH or PUSCH are quasi co-located (QCL) with a set of RSs in the two common TCI states with respect to a set of QCL parameters, or spatial transmit filters of the PUSCH are according to RSs configured with QCL-Type D of the two common TCI states.

12. The base station of claim 8, wherein, the signaling is a scheduling or activating DCI for the data transmission in the case that the data transmission is a PDSCH or a PUSCH expect for configured grant Type 1 PUSCH, and the beam indication information is indicated in a corresponding field in the scheduling or activating DCI wherein whether the corresponding field is present in the scheduling or activating DCI is configured by a radio resource control (RRC) signaling.

13. The base station of claim 8, wherein, the signaling is a radio resource control (RRC) configuration for the data transmission in the case that the data transmission is a configured grant Type 1 PUSCH.

14. The base station of claim 8, wherein, the two common TCI states are applicable from a first slot which is at least a number of symbols of acknowledgment of the first DCI, and the number of symbols is configured by a radio resource control (RRC) signaling based on a capability of a user equipment (UE).

15. A method at a user equipment (UE), the method comprising:
receiving a first downlink control information (DCI), wherein two common transmission configuration indication (TCI) states are indicated by a TCI field in the first DCI;
receiving a signaling including beam indication information for a data transmission, wherein the data transmission is a physical downlink shared channel (PDSCH) or a physical downlink shared channel (PUSCH); and
in the case that the two common TCI states are two joint or downlink (DL) common TCI states and the data transmission is a PDSCH, receiving the PDSCH according to the beam indication information in at least one slot indicated by the signaling where the two common TCI states are applicable; and
in the case that the two common TCI states are two joint or uplink (UL) common TCI states and the data transmission is a PUSCH, transmitting the PUSCH according to the beam indication information in at least one slot indicated by the signaling where the two common TCI states are applicable.

16. A processor for wireless communication, comprising:
at least one controller coupled with at least one memory and configured to cause the processor to:
receive a first downlink control information (DCI), wherein two common transmission configuration indication (TCI) states are indicated by a TCI field in the first DCI;
receive a signaling including beam indication information for a data transmission, wherein the data transmission is a physical downlink shared channel (PDSCH) or a physical downlink shared channel (PUSCH); and
in the case that the two common TCI states are two joint or downlink (DL) common TCI states and the data transmission is a PDSCH, receive the PDSCH according to the beam indication information in at least one slot indicated by the signaling where the two common TCI states are applicable; and
in the case that the two common TCI states are two joint or uplink (UL) common TCI states and the data transmission is a PUSCH, transmit the PUSCH according to the beam indication information in at least one slot indicated by the signaling where the two common TCI states are applicable.

17. The processor of claim 16, wherein, the beam indication information indicates a first common TCI state of the two common TCI states is determined for the PDSCH or PUSCH, wherein demodulation-reference signal (DM-RS) antenna ports of the PDSCH are quasi co-located (QCL) with a set of RSs in the first common TCI state with respect to a set of QCL parameters, or a spatial transmit filter of the PUSCH is according to a RS configured with QCL-Type D of the first common TCI state.

18. The processor of claim 16, wherein, the beam indication information indicates a second common TCI state of the two common TCI states is determined for the PDSCH or PUSCH, wherein demodulation-reference signal (DM-RS) antenna ports of the PDSCH are quasi co-located (QCL) with a set of RSs in the second common TCI state with respect to a set of QCL parameters, or a spatial transmit filter of the PUSCH is according to a RS configured with QCL-Type D of the second common TCI state.

19. The processor of claim 16, wherein, the beam indication information indicates both the two common TCI states are determined for the PDSCH or PUSCH, wherein demodulation-reference signal (DM-RS) antenna ports of the PDSCH are quasi co-located (QCL) with a set of RSs in the two common TCI states with respect to a set of QCL parameters, or spatial transmit filters of the PUSCH are according to RSs configured with QCL-Type D of the two common TCI states.

20. The processor of claim 16, wherein, the signaling is a scheduling or activating DCI for the data transmission in the case that the data transmission is a PDSCH or a PUSCH expect for configured grant Type 1 PUSCH, and the beam indication information is indicated in a corresponding field in the scheduling or activating DCI, wherein whether the corresponding field is present in the scheduling or activating DCI is configured by a radio resource control (RRC) signaling.
